(19) United States
(12) Patent Application Publication
(10) Pub. No.: US 2025/0066266 A1
(43) Pub. Date: Feb. 27, 2025

(54) METHOD FOR THE THREE-DIMENSIONAL DECORATION OF A SUBSTRATE TO PRODUCE AN EXTERNAL PART

(71) Applicant: Comadur SA, Le Locle (CH)

(72) Inventors: Damien LE BOUDOUIL, Valdahon (FR); Laurent Bourcet, Belfays (FR)

(73) Assignee: Comadur SA, Le Locle (CH)

(21) Appl. No.: 18/780,812

(22) Filed: Jul. 23, 2024

(30) Foreign Application Priority Data
Aug. 23, 2023 (EP) 23192994.4

(51) Int. Cl. C04B 41/86; B44C 1/00

(52) U.S. Cl. CPC C04B 41/86; B44C 1/00

(57) ABSTRACT

A method for the three-dimensional decoration of a substrate (11) to produce an external part (10) including the steps of: depositing at least one enamel carrier layer (12) on a decorative area of an external surface (110) of a ceramic substrate (11), the decorative area being intended to receive a decorative element (13); firing the substrate (11) comprising the carrier layer (12) so as to melt the latter; depositing a ceramic and/or metal decorative element (13) in solid form on the carrier layer (12); and sealing the decorative element (13) to the substrate (11) by firing to form an external part (10).

### CROSS REFERENCE TO RELATED APPLICATIONS

This application claims priority to European Patent Application No. 23192994.4 filed Aug. 23, 2023, the entire contents of which are incorporated herein by reference. Technical field of the invention.

### TECHNICAL FIELD OF THE INVENTION

The invention relates to the decoration of timepieces, jewellery or fashion items, and in particular to the manufacture of external parts.

More particularly, the invention relates to a method for the three-dimensional decoration of a substrate in order to produce an external part. This method can be advantageously applied to any external part in the field of watchmaking, jewellery, or fashion items such as leather goods, eyewear, writing instruments or portable electronic devices.

### TECHNOLOGICAL BACKGROUND

In the above-mentioned fields, external parts can be formed by assembling elements made from different materials. In particular, external parts comprising a metallic and/or ceramic decorative element fastened to a ceramic substrate are particularly attractive, although not very common due to the complexity of their manufacture.

More specifically, the very small dimensions of the decorative elements make them difficult to grasp and position on the substrate.

Another drawback of this type of assembly part is that the bond between the decorative element and the substrate cannot be controlled over time, as the decorative element is fastened to the substrate by driving, bonding or screwing.

### SUMMARY OF THE INVENTION

The invention overcomes the aforementioned drawbacks by proposing, for this purpose, a method for the three-dimensional decoration of a substrate in order to produce an external part, which method comprises the steps of:
depositing at least one enamel carrier layer on a decorative area of an external surface of a ceramic substrate, said decorative area being intended to receive a decorative element;
firing the substrate comprising the carrier layer so as to melt the latter;
depositing a decorative element made of a ceramic material and/or metallic material in solid form on the carrier layer, the material of which is chosen such that its melting temperature is higher than the glass transition temperature of the material constituting the carrier layer;
sealing the decorative element to the substrate by firing to form an external part.

In particular implementations, the invention can further include one or more of the following features, taken alone or according to any combination technically possible.

In particular implementations, the firing of the substrate and of the carrier layer, and the sealing of the decorative element to the substrate are carried out in the same step, when the melting temperature of the material constituting the decorative element is greater than 1000 degrees Celsius.

In particular implementations, a blind cavity is made in the substrate so as to form the decorative area and such that its shape corresponds to the shape of the decorative element, the latter being deposited so as to extend beyond said cavity.

In particular implementations, the cavity has a depth of at least 0.01 mm, preferably 0.1 mm.

In particular implementations, the carrier layer is made of borosilicate enamel or feldspar.

In particular implementations, the carrier layer is made of sodium borosilicate enamel.

In particular implementations, when the melting temperature of the material constituting the decorative element is below 1000 degrees Celsius, after the step of firing the substrate comprising the carrier layer, the latter is surfaced so as to flatten its surface and even out its thickness.

In particular implementations, during the sealing step, the temperature to which the substrate, the carrier layer and the decorative element are subjected is between 500 degrees Celsius and 1500 degrees Celsius.

### BRIEF DESCRIPTION OF THE FIGURES

Other features and advantages of the invention will become apparent from the following detailed description, which is given by way of example and is by no means limiting, with reference to the accompanying drawings in which:

FIGS. 1a to 1c diagrammatically show a sectional view of the steps involved in carrying out a method for decorating a substrate in order to produce an external part according to a first alternative embodiment of the invention;

FIGS. 1d to 1f diagrammatically show a sectional view of the steps involved in carrying out a method for decorating a substrate in order to produce an external part according to a second alternative embodiment of the invention.

It should be noted that the figures are not necessarily drawn to scale for clarity purposes.

### DETAILED DESCRIPTION OF THE INVENTION

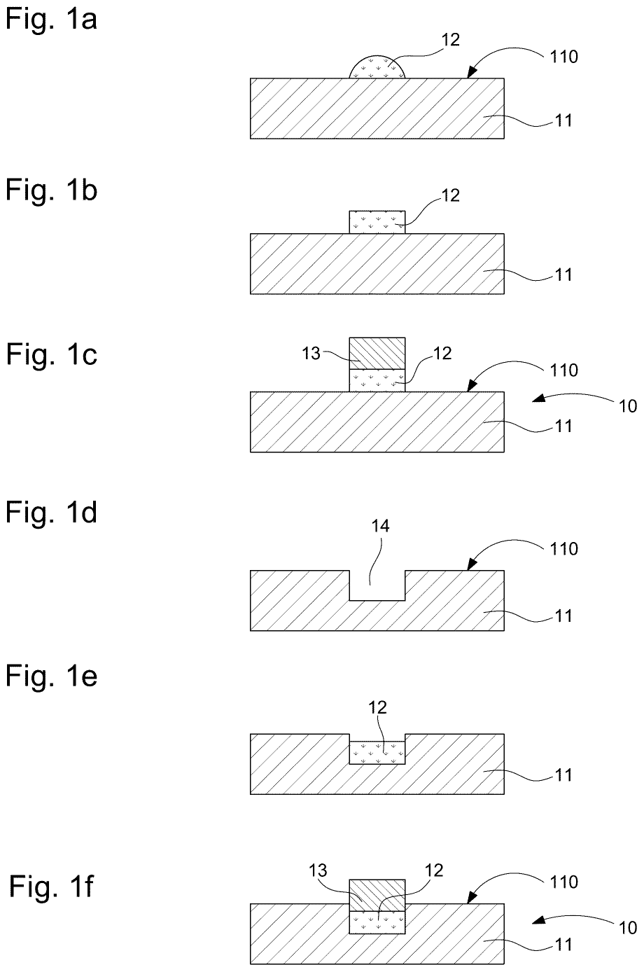

The present invention relates to a method for the three-dimensional decoration of a substrate 11 in order to produce an external part 10 as shown in two alternative embodiments in FIGS. 1c and 1f. More particularly, the steps of a first alternative implementation of the method are diagrammatically shown in FIGS. 1a to 1c, and are described initially below. The steps of a second alternative implementation of the method are diagrammatically shown in FIGS. 1d to 1f, and are described thereafter.

By way of example, in the field of watchmaking, the external part 10 can form a dial, a plate, a bridge, a gear train, an oscillating weight, a bezel, a middle, links of a bracelet or a clasp of a bracelet.

In the first alternative implementation, the method comprises a step of depositing at least one enamel carrier layer 12 on a decorative area of an external surface 110 of a substrate 11, as shown in FIG. 1a. The external surface 110 is intended to be visible to a user once the external part 10 has been produced. Furthermore, the decorative area constitutes a flat portion of the external surface 110 and is intended to receive a decorative element, as described in more detail below.

In this alternative embodiment of the invention, the carrier layer 12 is made of borosilicate enamel, for example sodium borosilicate, or feldspar. In this text, for reasons of language and to simplify reading, the singular is used when referring to the carrier layer 12, although the carrier layer 12 can be composed of a stack of layers.

Advantageously, the substrate 11 is made of ceramic, for example a dense ceramic, such as zirconia, alumina, Yttrium Aluminium Garnet (also known by the acronym “YAG”), sapphire or a mixture of these elements.

The substrate 11 and the carrier layer 12 are then fired in an oven at a temperature of between 500 and 1500 degrees Celsius, preferably 1000 degrees Celsius, so as to cause the carrier layer 12 to melt and adhere chemically to the substrate 11. Thanks to its composition, the adhesion of the carrier layer 12 to the substrate 11 is guaranteed following this step.

The carrier layer 12 is preferably surfaced following the firing step, as illustrated diagrammatically in FIG. 1b, so as to flatten its visible surface and even out its thickness. More specifically, as FIG. 1a shows in an exaggerated fashion, the carrier layer 12 is likely to vary in thickness. In particular, the surface of the base layer 12 can have a succession of hollows and bulges due to a surface tension phenomenon occurring during the firing of the base layer 12, and the thickness of the base layer 12 can be greater at the centre of the external surface 110 than at its periphery due to the wettability of said layer. Furthermore, if the external surface 110 does not extend horizontally, i.e. forms a slope, the base layer 12 can have a tendency to flow in the direction of the slope during firing, and thus to generate an excess thickness, under the effect of gravity and due to its hot viscosity.

The carrier layer 12 is preferably surfaced by mechanical abrasion, for example by grinding or sanding.

A decorative element 13 is then deposited on all or part of the carrier layer 12, as shown in FIG. 1c. Such a decorative element 13 is deposited in solid form. The decorative element 13 is advantageously made of a ceramic material and/or a metallic material, the material of said decorative element 13 being chosen so that it has a melting temperature higher than the glass transition temperature of the material constituting the carrier layer 12, for example higher than 600 degrees Celsius. In this text, the term “metallic material” refers to any metal alloy, any pure metal or any metal composite.

The decorative element 13 is then sealed onto the substrate 11 by firing the assembly consisting of the substrate 11, the carrier layer 12 and the decorative element 13, so as to form an external part 10. Firing can be carried out at a temperature of between 500 degrees Celsius and 1500 degrees Celsius. The temperature of this firing corresponds to a glass transition temperature of the material of the carrier layer 12, and must be lower than the melting point of the material constituting the decorative element 13 so as not to cause it to deteriorate.

Pressure can be applied to the decorative element 13 during firing to ensure its adhesion to the carrier layer 12. Such pressure can be exerted by a weight placed on the decorative element 13.

Firing of the substrate 11 and of the carrier layer 12 can advantageously be carried out during the step of sealing the decorative element 13 to the substrate 11 when the melting temperature of the material constituting the decorative element 13 is greater than 1000 degrees Celsius. Thus, a single firing step allows the carrier layer 12 to be melted and the decorative element to be sealed to the substrate 11. In this case, it is obvious that the method does not include a step of surfacing the carrier layer 12.

The second alternative embodiment of the invention corresponds to the first alternative embodiment described above, with the exception that a preliminary step is carried out before depositing the carrier layer 12, in which step a blind cavity 14 forming the decorative area is made in the substrate 11. In particular, the cavity 14 is made through the external surface 110. This cavity 14 is thus intended to receive the carrier layer 12 and the decorative element 13 when they are deposited respectively. It is produced such that its shape corresponds to the shape of the decorative element 13, as shown in FIG. 1f. This cavity 14 can be produced by laser machining.

Moreover, the decorative element 13 is deposited so as to extend beyond the cavity 14.

The cavity 14 has a depth of at least 0.01 mm, preferably 0.1 mm, to make it easier to position the decorative element 13 within the cavity 14.

In this alternative embodiment of the invention, the carrier layer 12 can be deposited in the cavity 14 in powder form.

More generally, it should be noted that the implementations and embodiments considered above have been described by way of non-limiting examples, and that other alternatives are consequently possible.

1. A method for the three-dimensional decoration of a substrate (11) to produce an external part (10) comprising the steps of:
depositing at least one enamel carrier layer (12) on a decorative area of an external surface (110) of a ceramic substrate (11), said decorative area being intended to receive a decorative element (13);
firing the substrate (11) comprising the carrier layer (12) so as to melt the carrier layer;
depositing a decorative element (13) made of a ceramic material and/or metallic material in solid form on the carrier layer (12), the material of the decorative element being such that its melting temperature is higher than the glass transition temperature of the material constituting the carrier layer (12);
sealing the decorative element (13) to the substrate (11) by firing to form an external part (10).

2. The method according to claim 1, wherein the firing of the substrate (11) and of the carrier layer (12), and the sealing of the decorative element (13) to the substrate (11) are carried out during the same step, when the melting temperature of the material constituting the decorative element (13) is greater than 1000 degrees Celsius.

3. The method according to either claim 1, wherein a blind cavity (14) is made in the substrate (11) so as to form the decorative area and such that a shape thereof corresponds to a shape of the decorative element (13), the decorative element being deposited so as to extend beyond said cavity (14).

4. The method according to claim 1, wherein a blind cavity (14) is made in the substrate (11) so as to form the decorative area and such that a shape thereof corresponds to a shape of the decorative element (13), the decorative element being deposited so as to extend beyond said cavity (14), the cavity (14) having a depth of at least 0.01 mm.

5. The method according to claim 1, wherein the carrier layer (12) is made of borosilicate enamel or feldspar.

6. The method according to claim 5, wherein the carrier layer (12) is made of sodium borosilicate enamel.

7. The method according to claim 1, wherein, when the melting temperature of the material constituting the decorative element (13) is below 1000 degrees Celsius, after the step of firing the substrate (11) comprising the carrier layer (12), the carrier layers is surfaced so as to flatten its surface and even out its thickness.

8. The method according to claim 1, wherein, during the sealing step, the temperature to which the substrate (11), the carrier layer (12) and the decorative element (13) are subjected is between 500 degrees Celsius and 1500 degrees Celsius.
